(19) United States
(12) Patent Application Publication
(10) Pub. No.: US 2019/0129368 A1
(43) Pub. Date: May 2, 2019

(54) CLUSTER CONTROL OF HETEROGENEOUS CLUSTERS OF THERMOSTATICALLY CONTROLLED LOADS USING TRACKER DEVICES

(71) Applicants: KATHOLIEKE UNIVERSITEIT LEUVEN, Leuven (BE); VITO NV, Mol (BE)

(72) Inventors: Sandro IACOVELLA, Genk (BE); Geert DECONINCK, De Pinte (BE); Bert CLAESSENS, Kermt (BE)

(73) Assignees: KATHOLIEKE UNIVERSITEIT LEUVEN, Leuven (BE); VITO NV, Mol (BE)

(21) Appl. No.: 16/096,343

(22) PCT Filed: Apr. 29, 2016
(86) PCT No.: PCT/EP2016/059695

§ 371 Date: Oct. 25, 2018

(51) Int. Cl. G05B 19/042; G06N 20/00

(52) U.S. Cl. CPC G05B 19/042; G05B 2219/2639; G06N 20/00

(57) ABSTRACT

Control methods, systems and controllers of devices in an electrical or heat distribution network which devices can be, for example, particularly or mainly thermostatically controlled loads (TCL) such as heat pumps. The methods are based on modeling a network with representative simulated tracer devices. Preferably, only a limited number of simulated tracer devices are used, i.e. limited in number compared to the number of devices in the electrical or heat distribution network. The simulated tracer devices are preferably governed by and have characteristics that are similar to those of actual devices in the electrical or heat distribution network or are representative of a major type of such devices. These simulated tracer devices can be used to represent behavior, for example, of an entire cluster of homogeneous or heterogeneous TCLs.

The present invention relates to methods, controllers and systems for the control of distribution systems like energy distribution systems, e.g. heat or electrical power distribution as well as software which when executed on a processing engine is able to perform any of such methods.

### BACKGROUND

WO 2011/074950 describes a market-based demand side management system as known in the art. The power/energy a device wants to consume or can produce is translated into a bidding function. By combining the bidding functions of all devices taking part in the demand response, a demand-supply balance is found. All devices consume/produce the power that, according to their bidding function, corresponds with the market balance priority. WO'950 provides a robust, simple, generic mechanism where privacy is guaranteed, as the devices only communicate their bidding function.

However, high penetration of wind or solar power challenges the future grid operation. Proper electric system operation requires a way to handle the effects of the variability and randomness of wind or solar power and power of other intermittent sources. When transferring the philosophy of demand side management (DSM) for wind power balancing, one preferably has to match the consumer demand with the power generation, rather than to use expensive reserves of flexible generators. Different electric appliances commonly found in a household can shift their consumption over different time slots. Examples of these flexible devices are refrigerators, air conditioners, dish washers, electric boilers and electric vehicles (EVs). In case of a high excess of wind energy most flexible devices will preferably consume power. This might overload the low voltage network distribution transformer or making it difficult to comply with national standards to keep the voltage within acceptable limits. Simultaneous charging of electric vehicle can create undervoltage problems in low voltage networks. Therefore measures needs to be taken to avoid voltage problems. DSM can also be applied to avoid transformer overloading or voltage profile control in distribution systems. Studies have shown that load response is an effective measure to solve power system constraints in a distribution system with high wind power penetrations. As DSM will involve millions of customers, centralized control will be not manageable as limits of computational complexity and communication overhead will be reached. Different authors therefore propose multi-agent systems to obtain a scalable system. A multi-agent system can be applied to reduce imbalance costs with EVs. A multi-agent based Virtual Power Plant consisting of domestic devices can be created to compensate imbalance caused by wind energy. Reducing peak demand can be obtained with a decentralized control.

Ideally at all times during operation of an electricity or heat distribution there needs to be a balance between production and consumption. With a continued integration of renewable energy, these balancing requirements become more demanding in terms of energy and power and speed of reaction. Inefficiencies can be incurred when ramping up of mainly gas fired power plants is necessary which have unfavorable energy efficiencies. This results in excessive energy consumption and pollution. Demand flexibility of large clusters of flexibility carriers, such as electric vehicles (EVs) and thermostatically controlled loads (TCLs) can help mitigate power imbalances related to increased renewable generation and electrification of heating and transportation. Aggregated control of large populations of appliances such as residential appliances in demand response systems offers several advantages compared with the interaction with a small number of large customers. Aggregate power consumptions can exhibit continuous behavior as opposed to generally discrete control responses of large customers. Of the different types of residential loads, TCLs such as air conditioners, water heaters, electric heaters, and heat pumps possess considerable potential for direct load control since they represent approximately 20% of the total electric energy in a country such as USA. Furthermore, temperature constraints set by the user can be manipulated by the aggregator while remaining within comfort constraints. However, there is a risk of correlated behavior in large heterogeneous clusters of residential devices which can result in unstable aggregated transients. In addition, as the installed capacity of intermittent and unpredictable generation increases, the stochastic nature of wind and solar output may result in increased imbalances that system operators have to deal with. The development of an efficient, practical and reliable control schemes poses a significant problem because of the large dimensionality of the problem and the need to absorb significant transients.

A centralized manner of controlling an aggregated heterogeneous cluster of TCLs would require simulating thousands of individual TCLs [1], [2] using first [3] or second order models [4]. This approach is intractable due to several reasons. First, individual TCL parameters, states, and human behavior factors are difficult to predict on an individual household level [5]. Secondly, the computational burden for optimal control of thousands of TCLs is very large [6] and problems remain even if distributed optimization approaches are used [7].

Distributed optimization approaches have planning issues. Therefore, numerous simplified aggregated models have been proposed. Early work on aggregated modeling of TCLs can be found in [3], [8] and this had the drawbacks of a difficult solution computation and controller design. More recently, a different class of linear population-bin transition models based on Markov chains has been proposed, which mitigates these issues [9]. However, it has been shown that the aggregated forecasting capability deteriorates for longer prediction horizons or when the cluster is pushed repeatedly to its temperature limits [1]. Recent research indicates that using reduced order models in combination with a broadcasted dispatch control signal might offer a solution.

Time varying battery models with or without dissipation terms for TCL aggregation using various dispatch methodologies have been proposed. These are used to compute near-optimal control trajectories at a certain computational burden.

One problem is the neglect of second-order dynamic effects in both detailed and aggregated representations. Another is ignoring heterogeneity in the TCL population. The effects of cluster heterogeneity results in consumption deviations because of differences in thermal properties as well as comfort constraints.

Therefore, a need exists for improved methods and systems for distributing and/or controlling an energy flow in an electricity or heat network.

### REFERENCES

[1] Kamgarpour, M.; Ellen, C.; Soudjani, S. E. Z.; Gerwinn, S.; Mathieu, J. L.; Mullner, N.; Abate, A.; Callaway, D. S.; Franzle, M.; Lygeros, J., “Modeling options for demand side participation of thermostatically controlled loads,” in Bulk Power System Dynamics and Control—IX Optimization, Security and Control of the Emerging Power Grid (IREP), 2013 IREP Symposium, vol., no., pp. 1-15, 25-30 Aug. 2013
[2] Biegel, B.; Andersen, P.; Pedersen, T. S.; Nielsen, K. M.; Stoustrup, J.; Hansen, L. H., “Smart grid dispatch strategy for ON/OFF demand-side devices,” in Control Conference (ECC), 2013 European, vol., no., pp. 25412548, 17-19 Jul. 2013
[3] Ihara, S.; Schweppe, F. C., “Physically Based Modeling of Cold Load Pickup,” in Power Apparatus and Systems, IEEE Transactions on, vol. PAS-100, no. 9, pp. 4142-4150, September 1981
[4] Chassin, D. P.; Schneider, K.; Gerkensmeyer, C., “GridLAB-D: An open-source power systems modeling and simulation environment,” in Transmission and Distribution Conference and Exposition, 2008. T&D. IEEE/PES, vol., no., pp. 1-5, 21-24 Apr. 2008
[5] Biegel, B.; Andersen, P.; Stoustrup, J.; Madsen, M. B.; Hansen, L. H., “Lumped thermal household model,” in Innovative Smart Grid Technologies Europe (ISGT EUROPE), 2013 4th IEEE/PES, vol., no., pp. 1-5, 6-9 Oct. 2013
[6] Gatsis, N.; Giannakis, G. B., “Residential Load Control: Distributed Scheduling and Convergence With Lost AMI Messages,” in Smart Grid, IEEE Transactions on, vol. 3, no. 2, pp. 770-786, June 2012
[7] Toersche, H. A.; Bakker, V.; Molderink, A.; Nykamp, S.; Hurink, J. L.; Smit, G. J. M., “Controlling the heating mode of heat pumps with the TRIANA three step methodology,” in Innovative Smart Grid Technologies (ISGT), 2012 IEEE PES, vol., no., pp. 1-7, 16-20 Jan. 2012
[8] Malhamé, R.; Chong, Chee-Yee, “Electric load model synthesis by diffusion approximation of a high-order hybrid-state stochastic system,” in Automatic Control, IEEE Transactions on, vol. 30, no. 9, pp. 854-860, September 1985
[9] Mathieu, J. L.; Koch, S.; Callaway, D. S., “State Estimation and Control of Electric Loads to Manage RealTime Energy Imbalance,” in Power Systems, IEEE Transactions on, vol. 28, no. 1, pp. 430-440, February 2013
[10] Mathieu, J. L.; Kamgarpour, M.; Lygeros, J.; Callaway, D. S., “Energy arbitrage with thermostatically controlled loads,” in Control Conference (ECC), 2013 European, vol., no., pp. 2519-2526, 17-19 Jul. 2013
[11] Heussen, K.; Koch, S.; Ulbig, A.; Andersson, G., “Unified System-Level Modeling of Intermittent Renewable Energy Sources and Energy Storage for Power System Operation,” in Systems Journal, IEEE, vol. 6, no. 1, pp. 140-151, March 2012
[12] Wei Zhang; Kalsi, K.; Fuller, J.; Elizondo, M.; Chassin, D., “Aggregate model for heterogeneous thermostatically controlled loads with demand response,” in Power and Energy Society General Meeting, 2012 IEEE, vol., no., pp. 1-8, 22-26 Jul. 2012
[13] H. Hao, B. M. Sanandaji, K. Poolla, and T. L. Vincent, “Aggregate flexibility of thermostatically controlled loads,” IEEE Trans. on Power Syst., vol. 30, no. 1, pp. 1-10, June 2014.
[14] R. Pedersen, B. Biegel, J. Schwensen, J. Stoustrup, T. Green “Aggregation and Control of Supermarket Refrigeration Systems in a Smart Grid” IFAC 2014, August 2014.
[15] Vandael, S.; Claessens, B.; Hommelberg, M.; Holvoet, T.; Deconinck, G., “A Scalable Three-Step Approach for Demand Side Management of Plug-in Hybrid Vehicles,” in Smart Grid, IEEE Transactions on, vol. 4, no. 2, pp. 720-728, June 2013
[16] F. Ygge, “Market-oriented programming and its application to power load management,” Ph.D. dissertation, Dept. Comput. Sci., Lund University, Lund, Sweden, 1998.
[17] R. Rubinstein, “The cross-entropy method for combinatorial and continuous optimization,” Methodol. Comput. Appl. Probab., vol. 1, no. 2, pp. 127-190, September 1999.
[18] L. Busoniu, R. Babuska, B. De Schutter, and D. Ernst, Reinforcement Learning and Dynamic Programming Using Function Approximators. Boca Raton, Fla., USA: CRC Press, 2010.
[19] M. Gonzalez Vaya and G. Andersson, “Optimal bidding strategy of a plug-in electric vehicle aggregator in day-ahead electricity markets,” in Proc. 10th Int. Conf. Eur. Energy Market (EEM), Stockholm, Sweden, May 2013, pp. 1-6.
[20] L. Brotcorne, P. Marcotte, and G. Savard, “Bilevel programming: The Montreal school,” Inf. Syst. Oper. Res., vol. 46, no. 4, pp. 231-246, 2008.
[21] C. Audet, P. Hansen, B. Jaumard, and G. Savard, “Links between linear bilevel and mixed 0-1 programming problems,” J. Optim. Theory Appl., vol. 93, no. 2, pp. 273-300, 1997.
[22] G. Kunapuli, “A bilevel optimization approach to machine learning,” Ph.D. dissertation, Dept. Math., Rensselaer Polytech. Inst., Troy, N.Y., USA, 2008.
[23] S. Weckx, R. D'Hulst, and J. Driesen, “Primary and secondary frequency support by a multi-agent demand control system,” IEEE Trans. Power Syst., vol. 30, no. 3, pp. 1394-1404, May 2015.
[24] K. Vanthournout, R. D'hulst, D. Geysen, and G. Jacobs, “A smart domestic hot water buffer,” IEEE Trans. Smart Grid, vol. 3, no. 4, pp. 2121-2127, December 2012.
[25] M. A. Stephens, “EDF statistics for goodness of fit and some comparisons,” J. Amer. Stat. Assoc., vol. 69, no. 347, pp. 730-737, 1974.
[26] Reynders, Glenn; Diriken, Jan; Saelens, Dirk; “Quality of grey-box models and identified parameters as function of the accuracy of input and observation signals” Energy and Buildings, 82,263-274, 2014, Elsevier

### ABBREVIATIONS

TCL: Thermostatically controlled load (heat pump, air conditioning, electric water heater, refrigerator, deep freezer, . . . )
ML: Machine learning
TSA: Three-step-approach
EV: Electric vehicle
SoC: State-of-charge

### ETP: Equivalent Thermal Parameter

### SUMMARY OF THE PRESENT INVENTION

An aim of the present invention is to manage the aggregated demand of large heterogeneous clusters of energy consuming or generating devices especially Thermostatically Controlled Loads (TCLs) (i.e. to provide systems, methods and controllers).

Embodiments of the present invention relate to the control and operation of devices in an electrical or heat distribution network which devices can be, for example, particularly or mainly thermostatically controlled loads (TCL) such as heat pumps, air conditioners, refrigerators, electric water heaters, any system with thermal storage, e.g. thermal storage that stores excess thermal energy to be collected for later use, including heating for individual buildings, district, town or regional scale heat storage schemes, pump storage schemes, water or ice-slush tanks, underground heat storage in masses of native earth or bedrock accessed with heat exchangers in clusters of small-diameter boreholes, deep aquifers contained between impermeable strata, shallow, lined pits filled with gravel and water and top-insulated, or thermal storage systems using eutectic, phase-change materials.

For example, embodiments of the present invention provide electrical devices or heat storage devices and methods for balancing economically high shares of variable renewable electricity or heat production and integration of electricity and/or heating sectors in energy systems almost or completely fed by renewable energy.

Embodiments of the present invention provide control methods, systems and controllers based on modeling a network with representative simulated tracer devices. Preferably, only a limited number of simulated tracer devices are used, i.e. limited in number compared to the number of devices in the electrical or heat distribution network. The simulated tracer devices are preferably governed by and have characteristics that are similar to those of actual devices in the electrical or heat distribution network or are representative of a major type of such devices. Hence, the simulated tracer device can be a simulated device representative one or more types of TCLs and these simulated tracer devices can be used in embodiments of the present invention to represent behavior, for example, of an entire cluster of homogeneous or heterogeneous TCLs. However the present invention is not limited to TCL's. Embodiments of the present invention may be extended to photovoltaic or battery devices for example. The present invention includes within its scope more than one control scheme, e.g. a three step process in which the optimization is particularly suited to EV's or smart white good appliances combined with another control scheme, e.g. a three step process in which the optimization is particularly suited to TCL's. Thus embodiments of the present invention extend prior art schemes while maintain the capabilities of these known schemes. In embodiments of the present invention systems, methods and controllers are provided for controlling clusters especially large clusters of devices which consume or generate heat or electric power including devices that are thermostatically controlled loads (TCL).

The word “tracer device” is used in this application to refer to the fact that the representative simulated devices are used for tracking the behavior of the network, so that the behaviors of these devices are “traces” of this behavior. Thus simulated tracer devices can represent a class of actual devices in the network thus reducing the dimensionality of any optimization problem.

Embodiments of the present invention provide an accurate reduced order device model that can be used to describe the dynamics of an entire cluster of devices such as TCL's. In embodiments of the present invention the simulated tracer devices can be based on second order models of devices which are the same as or are representative of actual devices in the network, e.g. representative of higher order actual devices. These simulated tracer devices preferably can capture both steady-state and transient population dynamics, as well as, optionally, cluster heterogeneity.

These simulated, second order model devices can be identified in a nonintrusive manner, for example using Machine Learning (ML) techniques, and can capture both steady-state and transient population dynamics as well as cluster heterogeneity.

In embodiments of the present invention these simulated tracer devices are used in an optimization of the distribution of electric energy or heat energy in electrical power or heat distribution systems. Embodiments of the present invention can use a three step approach, e.g. aggregation, optimization and dispatch. Additionally, in some embodiments, the dispatch mechanism can be included in the optimization, further improving the tracking performance. The devices can be controlled in the dispatch phase by remote or local activations of ON/OFF switches or can make use of a modulated approach, e.g. by locally or remotely changing set points in local controllers.

In embodiments of the present invention, use of a parameterizable number of simulated tracer devices is useful in a tradeoff between computational intensity and accuracy. In particular, these simulated tracer devices can represent TCL's and other devices and can be used to create a scalable and parameterizable cluster model that allows to incorporate a device population and dispatch dynamics. Embodiments of the present invention can provide an advantage of better efficiency and economy of operation and less power deviations especially for those embodiments that integrate dispatch dynamics in the optimization. For example, root mean square dispatch errors can be reduced by more than 10% when integrating the dispatch mechanism. Networks can be controlled or operated with a low number of simulated tracer devices, or if more accuracy is required (at expense of increased computational effort) the number of simulated tracer devices can be increased.

Further advantages of embodiments of the present invention include a low computational complexity at device level and a tractable optimization at aggregator level.

Embodiments of the present invention provide systems and methods and controllers for a cluster of devices which consume or generate or store electricity or consume or generate or store thermal energy (hot or cold) including aggregate and dispatch control steps for a portfolio of flexibility carriers comprise the following steps.
1) Identifying representative tracer devices to provide a description and preferably a more accurate description of the dynamics of the entire cluster, e.g. as part of an initial configuration of the network.
2) Allowing for a parameterizable amount of tracer devices, which offers an adjustable tradeoff between complexity and tracking performance during dispatch, e.g. as part of an initial configuration of the network
3) Optionally, generating an aggregated model able to capture transient and steady state dynamics, e.g. as part of an operation phase of the network. For example, device state and parameter information of the entire cluster is optionally aggregated.
4) The cluster demand profile for the next time period is optimized by performing an optimization (optionally performed centrally or in a distributed manner, e.g. in the cloud) of the aggregated model of the simulated tracer devices including the dynamics of the simulated tracer devices and an optimal value is obtained, e.g. for power or energy for the next time step e.g. as part of an operation phase of the network.
5) The resulting optimal power or energy value is translated into individual or aggregated control signals e.g. as part of an operation phase of the network.
6) Based on the control signals, dispatching information is provided to the cluster, e.g. as a broadcast signal, e.g. as part of an operation phase of the network.
7) Optionally, both the dynamics of the tracer devices and the dispatch algorithm are explicitly included in the central optimization, which results in better tracking performance, e.g. as part of an operation phase of the network.

The devices of a cluster can be controlled either remotely or locally. Switches can be controlled locally or remotely to execute the dispatch information.

Embodiments of the present invention can make use of a second order equivalent thermal parameter (ETP) model to provide simulated tracer device descriptions, which can, for example, include the thermal mass of a building to capture steady-state and transient dynamics accurately. Embodiments of the present invention can avoid or reduce cluster state of charge (SoC) divergence, e.g. which can decrease and increase cyclically during the heating and cooling phases, respectively.

A second order heterogeneous aggregated model for defining the simulated tracer devices according to the present invention can capture steady-state and dynamic population behavior, and allows direct dynamic dispatch effect integration in the optimization.

Embodiments of the present invention can provide an aggregated model offering a closed-loop solution by using representative simulated second-order model tracer devices that allow to achieve a desired performance and complexity tradeoff. Higher order models are included within the scope of the invention.

In another aspect the present invention provides a computer based system for operating an electrical power or heat supply network having at least one cluster of a plurality of heat or electrical energy consuming devices and virtual simulated tracer devices to simulate a plurality of the electrical energy or heat consuming devices, the system comprising:

Means for generating an aggregated model of a cluster which aggregates device state and parameter information of the entire cluster

Means for optimizing a cluster demand profile for a next time period by performing an optimization of the aggregated model with the simulated tracer devices including the dynamics of the simulated tracer devices and generating a control action which is a direct or indirect power or energy value for the next time period,

Means for converting the control action to individual device or aggregated devices control signals;

Means for providing dispatching information to the cluster, based on the control signals, and the plurality of the electrical energy or heat consuming devices consuming electrical energy or heat in accordance with the dispatching information.

In another aspect the present invention provides a controller for controlling operation an electrical power or heat supply network having at least one cluster of a plurality of heat or electrical energy consuming devices and virtual simulated tracer devices to simulate a plurality of the electrical energy or heat consuming devices, the controller comprising:

Means for generating an aggregated model of a cluster which aggregates device state and parameter information of the entire cluster

Means for optimizing a cluster demand profile for a next time period by performing an optimization of the aggregated model with the simulated tracer devices including the dynamics of the simulated tracer devices and generating a control action which is a direct or indirect power or energy value for the next time period,

Means for converting the control action to individual device or aggregated devices control signals;

Means for providing dispatching information to the cluster, based on the control signals, to allow the plurality of the electrical energy or heat consuming devices to consume electrical energy or heat in accordance with the dispatching information in a next time step.

### BRIEF DESCRIPTION OF THE DRAWINGS

FIG. 1 illustrates a electrical supply network with which embodiments of the present invention can be used.

FIG. 2 shows a non-convex modular bid function for a simulated tracer device divided into three zones for Big-M reformulation, the original convex constraint thereby being converted to a set of constraints describing the same feasible set using auxiliary binary variables and additional constraints according to an embodiment of the present invention.

FIG. 3 (left) illustrates a bid function of a power modular TCL as used in embodiments of the present invention.

FIG. 3 (right) illustrates a bid function of a discrete TCL as used in embodiments of the present invention.

FIG. 4 is a flow diagram illustrating a method of configuring tracer devices according to an embodiment of the present invention.

FIG. 5 is a flow diagram illustrating a method according to an embodiment of the present invention.

FIG. 6 illustrates mean relative RMSE dispatch deviations when using TSA and enhanced TSA for optimizing a cluster of TCL's according to embodiments of the present invention. The lines with filled rounds in the upper pair of lines relate to an enhanced TSA process including the dispatch algorithm in the optimization whereas the upper line with unfilled squares is not enhanced in this way. The lines with filled rounds in the lower pair of lines relate to an enhanced TSA process including the dispatch algorithm in the optimization whereas the lower line with unfilled squares is not enhanced in this way, whereby CEM distributions are used for the lower pair.

### DEFINITIONS

The term “flexibility information” used in this application relates to a freedom to choose a time for use of power or energy. “Flexibility information of a device relates to the ability of the device to adjust a timing with respect to when energy is consumed or generated. From this flexibility comes the possibility to optimise use or generation of energy.

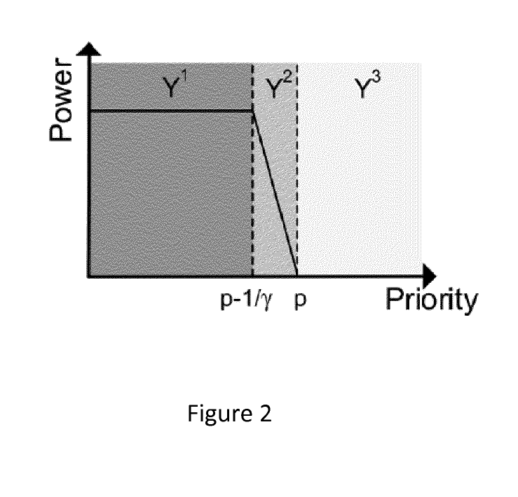

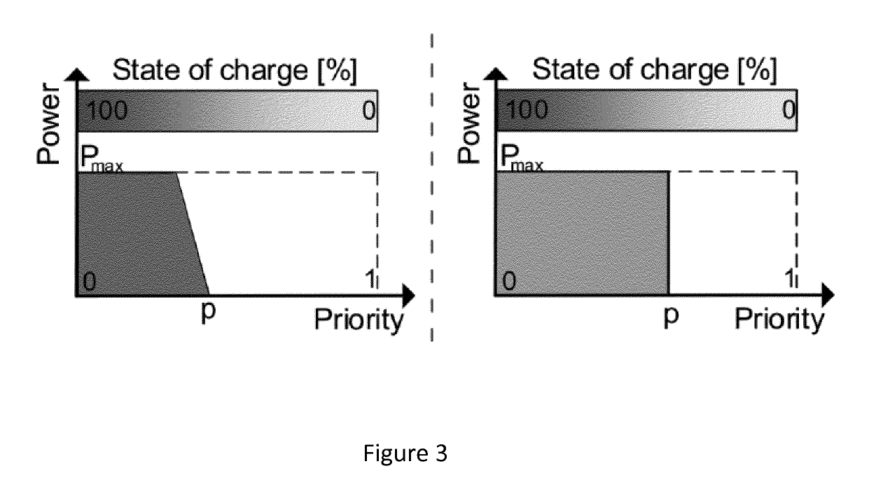

The term “bid or bidding function” used in the application relates to the need or necessity that a certain amount of power or energy is consumed or generated by a device. Hence this consuming or generating is in function of a virtual measure expressing the necessity or urgency of consuming energy, such as a priority, e.g. each device can define a necessity or need, i.e. a priority a consumer assigns to a certain power consumption or generation level. A bid function describes a relation between power consumption or generation and a virtual measure expressing the necessity or urgency of consuming power and/or energy referred to as a “priority” or necessity for distributing an energy flow. A bid or bidding function thus can be represented as an amount of power or energy to be traded as function of a virtual price or cost. The bidding functions may be piece-wise linear bid functions, for example. Generally a bidding function of a consuming device will have a negative slope, that is a high priority can only be associated with a low amount of energy or power. Thus the power or energy versus priority curve for a consuming device will have a negative slope optionally including steps. It can be a decreasing function such as a monotonically decreasing function. It can be a step-wise decreasing function, for example a monotonically decreasing function or a monotonically stepwise decreasing function. Priority is related to State of Charge (SoC). If the SoC of a device or cluster is low there is a need and hence a priority to charge. If the SoC is high there is only a low priority to charge. Several suitable bid functions are shown in FIGS. 2 and 3, FIG. 2 illustrating a step function with a linear decreasing function over at least part of the priority range and FIG. 3 right illustrating a single step function).

### DESCRIPTION OF ILLUSTRATIVE EMBODIMENTS

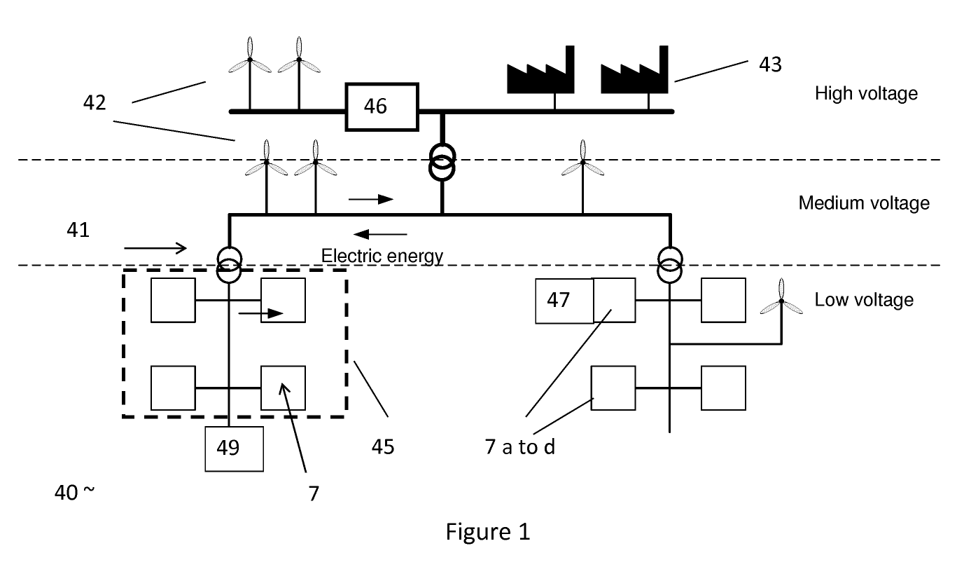

Embodiments of the present invention can be applied to a power system 40 shown schematically in FIG. 1 where there are different producers 42, 43 and consumer devices 7 or clusters 45 of consumer devices 7 which generate or consume electric energy (or generate and consume heat energy) and which are coupled through an electricity supply network 41. This electricity supply network 41 allows for generation and transmission of electric energy between consumer devices 7, and clusters of devices 45 and producers 42, 43 and can include a central controller 46 for controlling operation of the electricity supply network 41. There can also be local controllers 47 which control a consumer device 7 or a cluster controller 47 for controlling portion of the consumer devices 7 in a cluster 45.

Ideally at all times during operation of such a power system 40 there needs to be a balance between production and consumption. Embodiments of the present invention can be used in the control of the operation of the consumption of energy such as electricity of large heterogeneous clusters of consuming devices which exhibit some flexibility, i.e. having the freedom to adjust the usage of energy over time. The central controller 46 will in general carry out the optimization step whereas the cluster controller 49 and the local controller 47 will assist in the aggregation step and the collection of relevant information from the devices of the network. The cluster controller 49 and the local controller 47 can also assist in the dispatch step, i.e. with the broadcasting and receiving of commands.

Embodiments of the present invention provide a market based control of an electricity or heat supply network, whereby each possible equilibrium priority can result in a control of a consumption level of each device defined by a priority or by e.g. a bid function. The control function including implementation of a three step optimization can be carried out in a centralised controller or can be distributed over several controllers, e.g. cloud-based computing systems can be used where application functionality, memory, data storage and retrieval and relevant and required processing functions may be operated remotely from each other over a distributed computing network, such as the Internet or an intranet.

Embodiments of the present invention can make use of a three step process for the scalable control of TCL's for example. In the first step, flexibility information of the entire cluster population of homogeneous or heterogeneous devices is collected whereby in the case of large clusters the flexibility information is aggregated as disclosed below. In the second step, an aggregated model with reduced dimensionality is developed for the entire cluster, which makes the centralized optimization tractable. In the third step, the optimal control action, e.g. an optimal power set point or an ON/OFF control of switches is projected onto local control actions using a dispatch mechanism such as a market-based dispatch mechanism. This procedure allows for accurate TCL control.

In embodiments of the present invention, a method and a system and a controller are provided able to carry out a method whereby in the first step mentioned above, distributions of thermal properties and user comfort constraints are determined or estimated for devices such as household devices. In the second step mentioned above, representative simulated tracer devices with second-order models are used as a flexible reduced-order meta-model that describes the dynamics of the entire population of homogeneous or heterogeneous devices. An additional source of uncertainty concerns the reference signal tracking error as a result of using an identical broadcasted dispatch signal. Since power deviations can be costly, an extension to this embodiment with increased tracking performance is presented. The tracking performance can be enhanced by including dispatch dynamics explicitly in the optimization constraints. In the third step, a dispatch mechanism is provided.

Embodiments of the present invention use a second-order heterogeneous aggregated model which can capture steady-state and dynamic population behaviour, and also allows direct dynamic dispatch effect integration in the optimization.

Embodiments of the present invention provide aggregated models, systems and methods that offer a closed-loop solution by using representative second-order model simulated tracer devices that allow a desired performance and complexity trade-off to be achieved.

Managing the aggregated demand of large heterogeneous clusters of Thermostatically Controlled Loads (TCLs) is considered a sequential decision-making problem under uncertainty. Efficient, practical, and reliable control schemes, systems and methods according to embodiments of the present invention, including combinations of such control schemes, systems and methods allow control of large numbers of devices thus providing a solution to the dimensionality problem. By using representative second-order model simulated tracer devices, embodiments of the present invention offer a scalable and nonintrusive solution capturing steady-state and dynamic population behaviour.

Embodiments of the present invention make use of a Three-Step Approach (TSA). Embodiments of the present invention are adapted to provide for TCLs transient and steady-state thermal dynamics by identifying a set of simulated tracer devices. Use of these simulated tracer devices allows an estimation at least of the evolution of the state density distribution of the entire cluster. Embodiments of the present invention using these TCL simulated devices provide a scalable and parametrizable cluster model that allows to incorporate population and dispatch dynamics.

Embodiments of the present invention offer significant practical advantages, such as a low computational complexity at device level and a tractable optimization at aggregator level. Embodiments of the present invention provide an accurate reduced-order model that describes the dynamics of the entire cluster. Additionally, the dispatch dynamics can be included explicitly in the central optimization in further embodiments of the present invention. These embodiments improve the accuracy and results in better tracking performance.

Embodiments of the present invention involve a configuration phase:
Identifying representative simulated tracer devices to provide a more accurate description of the dynamics of an entire cluster of TCLs and/or other devices. For example, the aggregated model and system is able to capture transient and steady state dynamics since air and mass temperatures are taken into account.

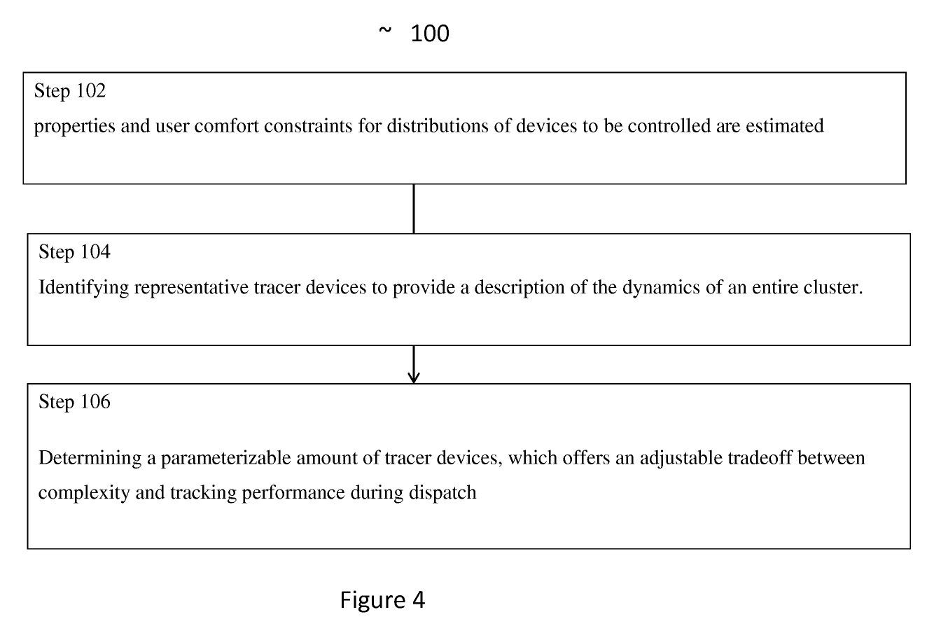

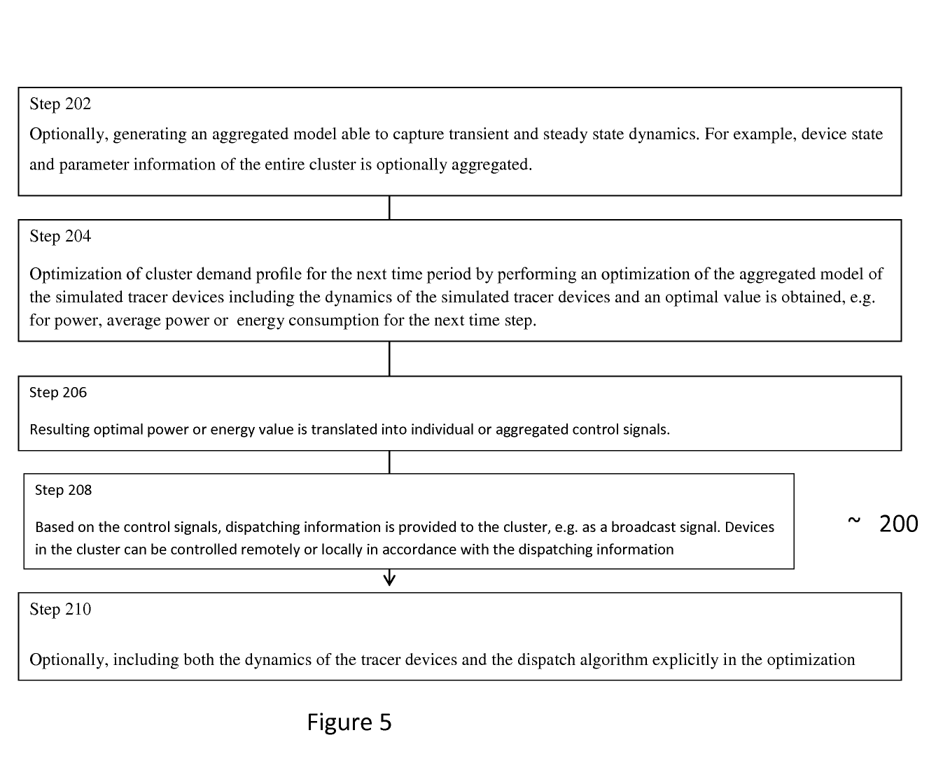

For example, the control function is first configured preferably by a method 100 shown in FIG. 4 in accordance with an embodiment of the present invention. This method identifies simulated tracer devices to be used in a method, system or controller for executing control. Such a method of control 200 is shown in FIG. 5.

These methods can
Include the dynamics of the simulated tracer devices and optionally include the dispatch algorithm explicitly in the optimization, which results in better tracking performance and improved service provisioning.
Allow for a parametrizable amount of simulated tracer devices, which offers an adjustable trade-off between complexity and tracking performance during dispatch. This enables application of embodiments of the present invention in a multitude of demand response services.

In a first step of an embodiment of the present invention, properties and user comfort constraints for distributions of thermal household devices (or other devices) are estimated (step 102 in FIG. 4). In the second step, representative simulated tracer devices, e.g. with second-order models, are identified (step 104 in FIG. 4) and a parametrizable amount of simulated tracer devices, which offers an adjustable trade-off between complexity and tracking performance during dispatch is determined (step 106 in FIG. 4).

In a method to control and operate an network according to an embodiment of the present invention (steps 202 to 208 of FIG. 5) the representative simulated tracer devices, e.g. with second-order models, are used as a flexible reduced-order meta-model that describes the dynamics of the entire population of heterogeneous devices of a cluster. An additional source of uncertainty concerns the reference signal tracking error as a result of using an identical broadcasted dispatch signal. Since power deviations can be costly, an extension to this method with increased tracking performance is provided in further embodiments of the present invention. The tracking performance can be enhanced in embodiments of the present invention by including the dispatch dynamics explicitly in the (second step) optimization constraints (step 210 in FIG. 5). In the third step, a suitable dispatch mechanism to the clusters and to the TCLs and/or other devices is used such as EVs or batteries (steps 206, 208 in FIG. 5).

With respect to other devices that can be used in embodiments of the present invention the TSA as proposed in embodiments of the present invention is not limited to devices that create their energy and power constraints locally and send them to an aggregator agent. For example with EV's arrival and departure times are usually specified manually, so that these are typically well-known. This also applies for smart white good appliances where the user explicitly enters completion deadlines and manufacturers provide power train profiles for chosen programs. Embodiments of the present invention are suited not only for such devices but also TCLs. For TCL's it is generally much harder to derive individual energy constraints, which require accurate forecasting of local heat demand and a calibrated physical model. To capture cluster heterogeneity and dynamics, embodiments of the present invention provide a TCL flexibility learning method at an aggregated level. The methodology is summarized in Algorithm 1 below.

Algorithm 1 TCL Populations Parameter Fitting Using CEM

| Input: CEM parameters | | | |
|---|---|---|---|
| nₚₒₚ | : population size | , nₚₐᵣ | : number of parameters |
| n_{trac} | : number of tracers | , n_{gen} | : number of generations |
| nₚₜₛ | : number of parents | , N | : runner of TCLs |
| α | : learning rate | , f | : fitness function |

| | : Initial ETP and SoC estimates | |
|---|---|---|
| μ₁ | = (μ₁¹,...,μ₁^{npar}) | , σ₁ = (σ₁¹,...,σ₁^{npar}) |
| ^{p}μ | = (^{p}μ₁,...,^{p}μ_{T}) | , ^{p}σ = (^{p}σ₁,...,^{p}σ_{T}) |
| | : Historic data | |
| P₁ | = (P_{1,1},...,P_{1,T}) | : aggregated TCL power |
| p | = (p₁,...,p_{T}) | : TCL corner priorities |
| p* | = (p₁*,...,p_{T}*) | : clearing priorities |

| | |
|---|---|
| 1: | t ← 1 |
| 2: | repeat |

| | |
|---|---|
| 3: | for i = 1,...nₚₒₚ do |
| 4: | for j = 1,...,n_{trac} do |

| | |
|---|---|
| 5: | Generate sample a_{i,j} from [symbol] (μₜ, σₜ) |
| 6: | Simulate tracer power consumption \hat{P}_{i,j} and |
| | priorities \hat{p}_{i,j} using Eqs. (3), (10-11), (16-17), |
| | (24) and Algorithm 2:(\hat{P}_{i,j}, \hat{p}_{i,j}) ← f(p*,a_{i,j}) |

| | |
|---|---|
| 7: | Compute [symbol] (^{p}\hat{μ}ₜ, ^{p}\hat{σ}ₜ) and \hat{P}₁ (14) |
| 8: | Compute s₁(a) using (13), sort s.t. s₁ ≤ ... ≤ sₙ_{ₚₒₚ} |
| 9: | Select nₚₜₛ best s₁(a), compute [symbol] (\hat{μ}ₜ, \hat{σ}ₜ) |
| 10: | μₜ₊₁ ← α\hat{μ}ₜ + (1 − α)μₜ |
| 11: | σₜ₊₁ ← α\hat{σ}ₜ + (1 − α)σₜ |
| 12: | t ← t + 1 |

| | |
|---|---|
| 13: | until t = n_{gen} |
| | Output: Best distributions a* = (μ*, σ*) and s* = s(a*) |

In a second optimization step, the aggregated model is built using L representative sampled simulated tracer devices. An optimal collective demand profile for the cluster of TCLs is derived based on the sampled tracer device parameters, with a power consumption scaled according to the undersampling factor U=N/L. The resulting Linear Programming (LP) optimization problem can be solved rapidly for many simulated tracer devices. However, it does not include the dispatch dynamics. To include these, simulated tracer device consumption of energy, e.g. TCL consumption of energy needs to be constrained for each of the upcoming optimization time steps to their respective piece-wise linear bid functions. Implicit inclusion of the dispatch dynamics into the optimization allows for the use of the resulting optimal market priorities in the real-time control step. This closed loop approach translates to a decrease in dispatch deviations compared with the open-loop receding horizon optimization. For example the TSA model according to an embodiment of the present invention which includes despatch dynamics has been implemented using the commercial CPLEX solver (version 12.6) by adding additional constraints in the TSA optimization problem.

In the final real-time control step, a Walrasian dispatch mechanism can be used. A Walrasian auction is a type of simultaneous auction where each agent calculates its demand for the good at every possible price and submits this to an auctioneer. The price is then set so that the total demand across all agents equals the total amount of the good. Thus, a Walrasian auction perfectly matches the supply and the demand. With respect to any of the embodiments of the present invention a Walrasian dispatch mechanism requires each device and/or each cluster of devices to prepare (or to have prepared) a priority versus power or energy graph, e.g. for each time step. Instead of price, a priority or need or necessity of consuming energy or power is used to control equitably which devices can consume energy in the next time step. A value of priority is selected by the optimization step of the TSA such that if each device consumes the amount of energy that is related to that priority or to higher priorities then the total amount of energy consumed over the next time step should be the total amount available or closely related to it.

In the two following three step aggregating, optimizing and dispatch systems, methods, systems and controllers programmed in a computer based system to provide the relevant means, are described. These two approaches can be used to control the operation of different devices in parallel, e.g. batteries on the one hand and TCL's on the other in the same system. The disclosure of “Cluster control of heterogeneous clusters of thermostatically controlled loads using tracer devices”, by Sandro Iacovella et al, 1949-3053, 2015 IEEE, is incorporated herein by reference in its entirety.

A first embodiment of the present invention will now be described.

Step 1: Basic Aggregation Embodiment

In a first aspect of an aggregation step and also in means for aggregation provided by the computer based system, individual device consumption (or generation) constraints are aggregated. [symbol] is defined as the set of participating devices at time t∈T, which is assumed to remain equal over time. T equals the set of time samples with horizon T and granularity Δt

[symbol]

={1, . . . ,N}, [symbol] ={1, . . . ,T} (1)

The constraints can be classified into two types: 1) energy and 2) power constraints. Energy constraints Eᵢ^{max} and Eᵢ^{min} define the boundaries to which the energy can be shifted in time, whereas power constraints Pᵢ^{dem} express the limits to which the instantaneous power demand can be adjusted. They are aggregated by and means for aggregation as follows at each time step t:

E^{max}=Eᵢ₌₁^{N}Eᵢ^{max},E^{min}=Σᵢ₌₁^{N}Eᵢ^{min},P^{dem}=Σᵢ₌₁^{N}Pᵢ^{dem} (2)

Individual device power consumption P_{t,i} can vary between 0 and Pᵢ^{max}. All possible priority-dependent power values of a device i∈ [symbol] at time t=1 are given by the demand vector Pᵢ^{dem}, according to their piecewise linear bid function bᵢ(p)

$$\begin{matrix}{b}_{i} ( p ) = \{ \begin{matrix}{P}_{i}^{max} & 0 \leq {p}^{*} \leq {p}_{i} - 1 / γ \\ γ {P}_{i}^{max} ( {p}_{i} - p ) & {p}_{i} - 1 / γ < {p}^{*} < {p}_{i} \\ 0 & {p}_{i} \leq {p}^{*}\end{matrix} & ( 3 ) \\ {P}_{i}^{dem} = \{ {P}_{i , p}^{dem} \vert {P}_{i , p}^{dem} = {b}_{i} ( p ) , ∀ p ∈ \{ 0 , … , 1 \} \} ∀ i ∈ & ( 4 )\end{matrix}$$

The scheduled and optionally consumed power at time step t thus depends on the corner priority p_{t,i} of device i, which specifies the necessity (or in other words a priority) for consuming power, the factor γ that determines the slope of the bid function allowing for power modular scheduling, and the equilibrium priority p *ₜ from the aggregator.

Step 2: Basic Optimization Embodiment

In the optimization step and in the means for optimization provided by the computer based system, an optimal collective charging plan or profile for the cluster of devices is derived at every time step based on the aggregated flexibility boundaries. The optimization problem for a generalized cost model can be formulated as follows:

P*=argmi [symbol] f(P) (5)

s.t.:0≤Pₜ≤P^{max}∀t∈ [symbol] (6)

Eₜ^{min}≤Eₜ≤Eₜ^{max}∀t∈ [symbol] (7)

Eₜ₊₁=Eₜ+PₜΔt∀t∈ [symbol] (8)

where f(P): [symbol] ^{t}→ [symbol] specifies the business case dependent objective function. P^{max} defines the cluster power limit. The resulting optimal aggregated power consumption P*={P*₁, P*_{T}} defines the collective charging plan for the entire fleet of devices and optimization horizon T. The collective charging power for the upcoming time step P*₁ is translated in the subsequent third step to an optimal clearing priority p* for individual device control.

Step 3: Basic Real-Time Control Embodiment

Finally, in the real-time control step and in the means for real time control provided by the computer based system, a uniform control signal is created for all devices by using a Walrasian market mechanism with demand and supply functions [16]. The corner priority heuristics pᵢ for each device determine the inflection points of the aggregated demand function P^{dem}. This vector is then used to translate P*₁ to an optimal clearing priority p*

p*=argmin_{p*∈{0, . . . ,1}}|Σₙ₌₁^{N}Pᵢ^{dem}−P₁*| (9)

This clearing priority is sent to all clusters and/or devices and/or device agents, which identify their individual optimal charging power P_{1,i} locally based on their bid function bi(p*) (3). Hence the computer based system is adapted to send this clearing priority to all clusters and/or devices and/or device agents, which identify their individual optimal charging power P_{1,i} locally based on their bid function bi(p*) (3). The devices can be controlled remotely or locally, e.g. by remotely operated local switches or by local control of such switches, or by remote or local modulation of the operation of the devices e.g. by changing a set point of a local controller. This local control can be performed, for example by a demand response adaptor as disclosed in EP-A-2 618 445 which is incorporated herein by reference.

The three steps of aggregation, optimization, and dispatch are repeated in a receding horizon manner. Hence the means for aggregation, optimization, and dispatch are adapted to repeat these steps in a receding horizon manner.

Step 1: Aggregation—Embodiment of the Invention

Embodiments of the present invention provide methods, systems and/or controllers adapted to capture cluster device heterogeneity and dynamics, using a TCL flexibility learning method at an aggregated level. Firstly, a representative ensemble of simulated (virtual) tracer devices is identified that can describe population dynamics of the devices in the network. Hence the computer based system is adapted to use a virtual representative ensemble of simulated (virtual) tracer devices and to identify such virtual tracer devices that can describe population dynamics of the physical devices in the network These virtual tracer devices can be based on a suitable second order model, for example, an ETP model. As an example, the thermal environment of residential housing can be modelled based on interior air (Tₐ) and mass structure (Tₘ) temperature differential equations for the ETP model of a residential heating/cooling system:

$$\frac{{dT}_{a}}{dt} = \frac{1}{{C}_{a}} [ {T}_{m} {H}_{m} - {T}_{a} ( {U}_{a} + {H}_{m} ) + {Q}_{a} + {T}_{0} {U}_{a} ] \\ \frac{{dT}_{m}}{dt} = \frac{1}{{C}_{m}} [ {H}_{m} ( {T}_{a} - {T}_{m} ) + {Q}_{m} ] \qquad ( 10 )$$

where Uₐ equals the conductance of the building envelope, Tₒ is the outside air temperature, Tₐ is the inside air temperature, and Tₘ is the inner mass temperature, Hₘ is the conductance between the inner air and the solid mass. Cₐ and Cₘ represent the thermal mass of the air and interior solid mass, respectively. The heat flux into the interior air mass Qₐ is given by a fraction a of the solar heat gains Qₛ, a fraction of the heat gains of the internal loads Qᵢ, and the heat gain generated by the heat pump Qₕₚ. The latter equals the heat pump power Pₕₚ multiplied with its coefficient of performance (COP). The remaining fraction of Qᵢ and Qₛ is added to the interior solid mass Qₘ

Qₐ=αQₛ+βQᵢ+Qₕₚ

Qₘ=(1−α)Qₛ+(1−β)Qᵢ

Qₕₚ=PₕₚCoP. (11)

The use of higher order models is included within the scope of the present invention and are reported in [26].

Identifying the ETP model parameter distributions for a heterogeneous collection of thousands of TCLs can be determined by different methods of which one is the cross-entropy method (CEM) [17], which is closely related to estimation of distribution algorithms (EDAs). This algorithm is a simple, efficient and general method of solving a great variety of estimation, and optimization problems, especially NP-hard problems. Other techniques such as genetic algorithms can also be used for this distribution fitting.

The CEM aims to find the (approximate) optimal solution s* for a learning task defined as [18]

$${s}^{*} = s ( a ) \qquad ( 12 )$$

With s:A→ [symbol] the fitness function that describes the quality of a solution. The methodology is summarized in Algorithm 1 and the computer based system is preferably adapted to execute this algorithm.

Vector a=(μ, σ) maintains ETP parameter (10), (11) densities from the domain A. Since it is desired to estimate these parameters in a nonintrusive way, this function is preferably based solely on observed aggregated power consumptions (P₁) and TCL corner (p) and clearing (p*) priorities over a time period T. This relaxation of total power estimation assumes that the parameters to be estimated are within the same order of magnitude (for example no combinations of large industrial and small domestic TCLs). CEM converges to s* by iteratively drawing samples a from the ETP parameter densities N (μₜ,σₜ) (line 5 of Algorithm 1). The sampled ETP parameter values a_{i,j} are used to create representative tracer devices. From line 6 of Algorithm 1, it can be seen that their power consumption \hat{P}_{i,j} and priorities \hat{p}_{i,j} are simulated by using the temperature differential equations (eq 10), (11), initial values (16), and comfort boundaries (17). These sampled devices then respond locally to the observed market priorities p* based on their priority-dependent (24) bid function (3). The backup controller from Algorithm 2 overrules set points when temperature constraints are violated. Finally, their fitness value s(a) is calculated in line 8 and the ETP model probability distribution parameters

sᵢ(a)=(P₁−\hat{P}ᵢ)²+(^{p}μ−^{p}\hat{μ}ₜ)²+(^{p}σ−^{p}\hat{σ}ₜ)² (13)

Algorithm 2 Local Hysteresis Control

| | |
|---|---|
| 1: | if Tₐ ≤ Tₛₑₜ − T_{db} or hysteresis ≥ 1 then. |

| | |
|---|---|
| 2: | Qₕₚ = P^{max}COP |
| 3: | hysteresis = hysteresis + 1 |
| 4: | if hysteresis ≥ 15 or mod(t, Δt) then hysteresis = 0 |

| | |
|---|---|
| 5: | if Tₐ ≥ Tₛₑₜ + T_{db} then |

| | |
|---|---|
| 6: | Qₕₚ = 0 |
| 7: | hysteresis = 0 |

This minimization is based on observed and simulated total cluster power consumptions (Pi, \hat{P}i) and priority distributions (N(^{p}μ,^{p}σ), N(^{p}\hat{μ}ₜ,^{p}\hat{σ}ₜ) deviations where (line 7)

$${\hat{P}}_{i} = \frac{N}{{n}_{trac}} {\sum }_{j = 1}^{{n}_{trac}} {\hat{P}}_{i , j} \qquad ( 14 )$$

[symbol] is redefined as the set of the TCL population, and [symbol] ₗ⊂ [symbol] is defined as the representative subset of simulated tracer devices. Furthermore, [symbol] equals the set of time samples used for the ETP model calculations, with horizon Tₛ and granularity Δtₛ

[symbol]

l={1, . . . ,L}, [symbol] ={1, . . . ,Tₛ} (15)

ETP model parameters are sampled for each simulated tracer device i from a*. Since only a limited number of tracer devices L are to be incorporated in the optimization problem, quota sampling is used by generating L equiprobable population segments. The TSA aggregated energy constraint vector (2) is replaced by the inside air and the mass temperature differential equations (10), which are initialized as

T_{a,1,i}=T_{a,i}^{init},T_{m,1,i}=T_{m,i}^{init}∀i∈ [symbol] ₗ (16)

The power constraint (6) now applies for each individual simulated tracer device with power limit Pᵢ^{max} whilst the energy constraint vectors Eᵢ^{max} and Eᵢ^{min} from (equation 2) are transformed into static air temperature boundaries Tᵢ^{max} and Tᵢ^{min} as specified by the user

T_{a,i}^{min}≤T_{a,t,i}≤T_{a,i}^{min}∀t∈ [symbol] ,∀i∈ [symbol] ₗ (17)

The computer based system is adapted to execute and to provide means for executing any of the steps of any algorithm described above.

B. Step 2: Optimization—Embodiment of the Invention

The main advantage of fitting probability distributions of model parameters from the entire TCL population of size N using n_{trac} simulated tracer devices, stems from the fact that the aggregated model can be built (and the computer based system can be programmed for) using a reduced number such as L representative sampled simulated tracer devices. The optimal collective demand profile for the cluster of TCLs is derived and the computer based system is adapted to derive and has means to derive the collective demand profile based on the sampled tracer device parameters, with a power consumption scaled according to the undersampling factor U=(N/L). The revised constraints for the original optimization problem (equation 5) can be summarized as follows:

P*=argmi [symbol] f(P)

s. t.:

(16)∀i∈ [symbol] ₗ

(6)∀i∈ [symbol] ₗ,∀t∈

[symbol]

(10),(11),(17)∀i∈ [symbol] ₗ,∀t∈ [symbol] (18)

This linear programming (LP) optimization problem, hereafter termed TSA, can be solved rapidly for many simulated tracer devices and the computer based system is adapted to solve and has means to solve the linear programming (LP) optimization problem. However these methods, systems and means but do not include the dispatch dynamics. To include these, TCL simulated tracer device consumption needs to be constrained (and the computer based system has means for constraining) for each of the T upcoming time steps to their respective piece-wise linear bid functions bi(p), resulting in a bilevel mathematical program. The upper level program constitutes the LP cost minimization problem (18), whereas the lower level problem constitutes the market clearing and corresponding equilibrium priority formation (9) [19], [20]. These two problems are linked through the equilibrium priority p*, appearing on both levels. The connections between bilevel programs and mixed integer programs (MIPs) are well known. It was shown in [21] that there exists an implicit reformulation of a bilevel program as an MIP. Specifically, this bilevel model can be reduced to a 0/1 MIP by introducing integer variables Y, and a large finite constant M [22]. To do so, an unconstrained bid function power variable P_{t,i}^{bf} is added first:

P_{t,i}^{bf}=γPᵢ^{max}(p_{t,i}−pₜ*) (19)

Since the consumable demand P_{t,i} is constrained to a bid function (3) for each simulated tracer device i∈ [symbol] ₗ, Big-M constraints are added for the zones Y¹, Y², and Y³ (see FIG. 2) at each timestep t

pᵢ^{max}−M(1−Y_{t,i}¹)≤P_{t,i}≤P_{t,i}^{bf}+M(1−Y_{t,i}¹) (20)

p_{t,i}^{bf}−M(1−Y_{t,i}²)≤P_{t,i}≤P_{t,i}^{bf}+M(1−Y_{t,i}²) (21)

p_{t,i}^{bf}−M(1−Y_{t,i}³)≤P_{t,i}≤M(1−Y_{t,i}³) (22)

Σⱼ₌₁³Y_{t,i}^{j}=1 (23)

As shown in FIG. 2, the nonconvex power modular bid function of each tracer device is divided into three zones (and the computer based system is adapted to divide) using the Big-M reformulation. The original nonconvex constraint is thereby converted to a set of constraints describing the same feasible set, using auxiliary binary variables, and additional constraints. The simplex algorithm is the original and still one of the most widely used methods for solving linear maximization problems. However, to apply it, the origin (all variables equal to 0) must be a feasible point. This condition is satisfied only when all the constraints (except non-negativity) are less-than constraints with a positive constant on the right-hand side. The Big M method introduces surplus and artificial variables to convert all inequalities into that form. The “Big M” refers to a large number associated with the artificial variables, represented by the letter M.

The steps in the algorithm are as follows:
Multiply the inequality constraints to ensure that the right hand side is positive.
If the problem is of minimization, transform to maximization by multiplying the objective by −1
For any greater-than constraints, introduce surplus and artificial variables (as shown below)
Choose a large positive M and introduce a term in the objective of the form −M multiplying the artificial variables
For less-than or equal constraints, introduce slack variables so that all constraints are equalities
Solve the problem using the usual simplex method.

Implicit inclusion of the dispatch dynamics into the optimization allows for the use of the resulting optimal market priorities p*={p* 1, . . . ,p* T} in the real-time control step and the computer based system is adapted to implicitly include the dispatch dynamics into the optimization and the computer based system allows for the use of the resulting optimal market priorities p*={p* 1, . . . ,p* T}. This closed-loop approach translates to a decrease in dispatch deviations compared with the open-loop receding horizon optimization from (18). This enhanced TSA model has been implemented using the commercial CPLEX solver (version 12.6) by adding (19)-(24) as constraints in the TSA optimization problem (18), ∀i∈ [symbol] ₗ,∀t∈ [symbol] .

### C. Step 3: Real-Time Control—Embodiment of the Invention

The Walrasian dispatch mechanism as discussed above is modified preferably in this embodiment and the computer based system is adapted to use the modified Walrasian dispatch mechanism. Firstly, the priority based control signal inherently minimizes ON/OFF switching actions. However under some circumstances a modulated control is preferable to ON/OFF control. For example for a building with an existing local controller it may be preferred to alter a set point for the controller rather than to interfere in the local switching process. Secondly a broadcasted equilibrium priority leads to minimal communication overhead and compatibility with other device classes [15]. Finally, these priorities can also be used to encode pricing and service quality [13]. As opposed to the strategies from [13] and scenarios 1 and 2 from [9] this dispatch mechanism does not require an expensive measurement of the power consumption of each TCL. The corner priority p_{t,i} equals the necessity of consumption for each TCL i at time instance t, which is dependent on the SoC

$${p}_{t , i} = 1 - SoC = \frac{{T}_{a , i}^{max} - {T}_{a , t , i}}{{T}_{a , i}^{max} - {T}_{a , i}^{min}} \qquad ( 24 )$$

The SoC is preferably the primary state indicator of a TCL such as a thermal buffer for any demand response control system [23] and does not require extensive local computational requirements [24]. The closer the temperature drops to the minimum local temperature comfort setting, the more urgent is its scheduling. The bid function of a discrete TCL with fixed maximum power consumption Pᵢ^{max} and priority p_{t,i} can be defined as (see FIG. 3 (right)):

b_{t,i}(p)=Pᵢ^{max}(1−H(p−p_{t,i}))∀p∈{0, . . . ,1} (25)

where H is the Heaviside step function. To minimize rounding errors when extrapolating the simulated tracer device power consumption to that of the cluster, it is assume that simulated tracer devices can modulate their power consumption, with bid functions that are identical or similar to those of EVs. A suitable bid function is shown in FIG. 3 (left).

An aggregator can minimize cost of electricity bought in a day-ahead setting for example, by setting control time steps its (e.g. of 1 minute), and it (e.g. of 15 minutes) and known prices λ∈ [symbol] :

f(P)=UΣₜ₌₁^{T}Σᵢ₌₁^{L}λₜP_{t,i}Δt (26)

The devices can be controlled remotely or locally, e.g. by remotely operated local switches or by local control of such switches, or by remote or local modulation of the operation of the devices e.g. by changing a set point of a local controller. This local control can be performed by a demand response adaptor as disclosed in EP-A-2 618 445 which is incorporated herein by reference.

The three steps of aggregation, optimization, and dispatch are repeated in a receding horizon manner. Hence the means for aggregation, optimization, and dispatch are adapted to repeat these steps in a receding horizon manner.

Determination of the Representative Tracer Devices

One method to find the representative simulated tracer devices is to use a “Goodness of Fit” test, for example convergence in the Goodness of fit can be understood from table II;

In accordance with embodiments of the present invention an increasing number of simulated tracer devices can be used until there is no or only marginal performance gain (e.g. less than 10% or 5% or 1% gain). The number of simulated tracer devices can be limited to the number when the marginal performance gain is lower than marginal operational/computational cost. Additionally, or alternatively the number of simulated tracer simulated devices can be selected to be equal to a minimal number of tracers as indicated during goodness-of-fit test and/or dispatch deviation results, using metrics known to the skilled person such as RMSE.

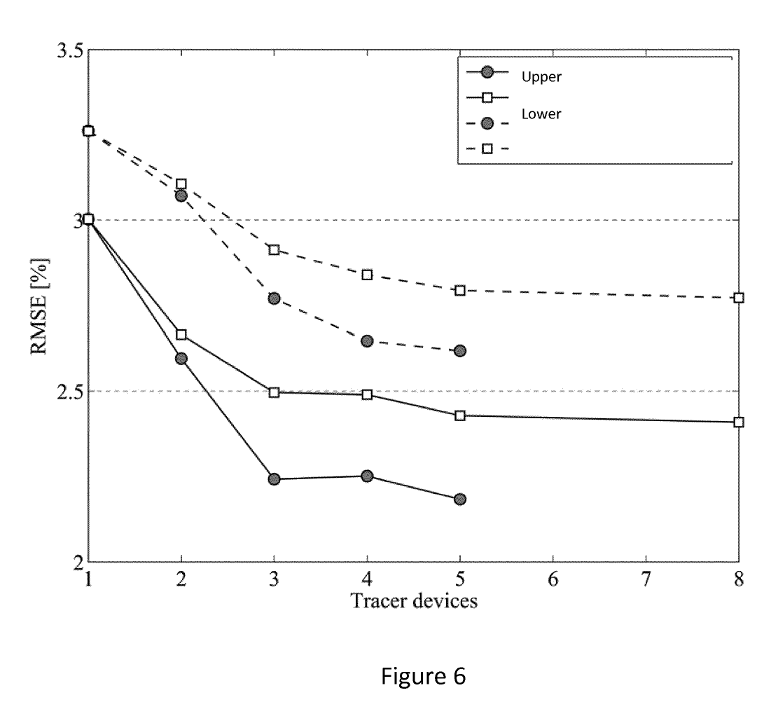

For example, assume that nₚₐᵣ=the number of 6 TCL population ETP parameters is chosen to be normally distributed stochastic variables (Table I). It is assumed that all other parameters are equal amongst all households. Parameter distribution identification is performed for n_{trac}∈{2,4,8,12} over a time period T of 96 quarter hours by observing P₁, p, and p*. ^{p}μ is initialized according to 1−p*, with ^{p}σ equal to 0.5. Initial ETP Gaussian probability distribution relative standard deviations for μ₁ and σ₁ are chosen as 5% and 15%, respectively. The remaining CEM parameters can be chosen as: α=0.5, nₚₒₚ=10,000 (this is the number of devices in cluster), n_{gen}=30, and nₚₜₛ=100. To estimate the parameter fitting performance, numerous goodness-of-fit tests can be used [25], for example the Anderson-Darling and Kolmogorov-Smirnov tests to verify the hypothesized nₚₐᵣ ETP (N(^{p}μ,^{p}σ)) and T priority (N(μ,σ)) distributions. The null hypothesis is that the sampled distribution corresponds to the actual distribution, whereas the alternative hypothesis is that it does not. A result of 1 indicates that the test rejects the null hypothesis at the 5% significance level, and vice-versa for a result of 0. The diminishing number of test rejections for increasing numbers of estimation tracer devices can be seen in Table II. The root mean square error (RMSE) deviations are also depicted in this table. All tests confirm the strongly diminishing benefits beyond n_{trac}=4. ETP distribution estimations for this quantity of simulated tracer devices are therefore used. Therefore as can be seen Table II and FIG. 6, the relative RMSE (normalized by range of optimized power values) dispatch deviation converges at 5 tracer devices for both techniques when sampling from either distribution. Therefore, there is a clear connection between the number of simulated tracer devices and the quality of the aggregated model and a quality criterion can be used to select the number of devices and their characteristics, e.g. that the dispatch deviation is less than 10% or 5% RMSE (see FIG. 6). Both methods according to the present invention being TSA and enhanced TSA (which is enhanced by including the dispatch algorithm in the optimization) exhibit a non-linear execution time for increasing numbers of simulated tracer devices. Because of the parametrizable nature of both control methodologies (TSA and enhanced TSA according to embodiments of the present invention), the number of simulated tracer devices used can be chosen depending on the respective business case timeslot length, i.e. how much time can be allowed for executing the optimisation of the second step. Since the control objective time slot period can exceed all execution times, the enhanced TSA approach with 5 tracers can be used in this business case, for example.

TABLE I
ETP SIMULATION PARAMETERS

| Parameter | Interpretation | Distribution | Unit |
|---|---|---|---|
| P^{max} | Maximum power | 2000 | [W] |
| COP | Coefficient of | 3 | [—] |
| | performance | | |
| α/β | Internal/solar loads | 0.5 | [—] |
| | fraction | | |
| Qᵢ/Qₛ | Internal/solar heat gain | 1 profile all HH | [W] |
| Tₒ | Outside temperature | 1 profile all HH | [° C.] |
| Tₐ^{init}/Tₘ^{init} | Initial air/mass | (Tₐ^{min} + Tₐ^{max})/2 | [° C.] |
| | temperature | | |
| Tₛₑₜ | Temperature setpoint | [symbol] (19, 0.5) | [° C.] |
| T_{db} | Temperature deadband | [symbol] (1, 0.25) | [° C.] |
| Uₐ | Thermal air conductance | [symbol] (332, 49.8) | [W/° C.] |
| Hₘ | Thermal mass | [symbol] (4491, 673.7) | [W/° C.] |
| | conductance | | |
| Cₐ | Thermal air capacity | [symbol] (11.59, 1.74)10⁶ | [J/° C.] |
| Cₘ | Thermal mass capacity | [symbol] (25.92, 3.89)10⁶ | [J/° C.] |

TABLE II
GOODNESS-OF-FIT TEST

Tracer devices (n_{trac})

| | 2 | 4 | 8 | 12 |
|---|---|---|---|---|
| RMSE [10⁵ W] | 6.69 | 2.44 | 2.43 | 2.43 |
| Anderson-Darling | 70 | 59 | 60 | 60 |
| Kolmogorov-Smirnov | 40 | 33 | 32 | 32 |

Computer Based Implementations

Any of the methods of the present invention described above can be performed by a controller (e.g. the central controller 46, and/or the cluster controller 49 and/or the local controller 47) with processing capability such as provided by one or more microprocessors, FPGA's, or a central processing unit (CPU) and/or a Graphics Processing Unit (GPU), and which is/are adapted to carry out the respective functions by being programmed with software, i.e. one or more computer programmes. References to software can encompass any type of programs in any language executable directly or indirectly by a processor, either via a compiled or interpretative language. The implementation of any of the methods of the present invention can be performed by logic circuits, electronic hardware, processors or circuitry which can encompass any kind of logic or analog circuitry, integrated to any degree, and not limited to general purpose processors, digital signal processors, ASICs, FPGAs, discrete components or transistor logic gates and similar.

Such a controller may have memory (such as non-transitory computer readable medium, RAM and/or ROM), an operating system, optionally a display such as a fixed format display, data entry devices such as a keyboard, a pointer device such as a “mouse”, serial or parallel ports to communicate other devices, network cards and connections to connect to any of the networks.

The software can be adapted to perform a method controlling demand of heat energy or electrical energy to be distributed to constrained cluster elements grouped in clusters in a demand response system when executed on a processing engine in the controller, for example. The software can be embodied in a computer program product adapted to carry out the means and functions itemised below when the software is loaded onto the controller and executed on one or more processing engines such as microprocessors, ASIC's, FPGA's etc. Hence controller for use with any of the embodiments of the present invention can incorporate a computer system capable of running one or more computer applications in the form of computer software. The controller is preferably the central controller 46, and/or the cluster controller 49 and/or the local controller 47.

The method, system and the controller can be adapted to determine the amount of the heat energy or electrical energy to be distributed to the constrained cluster elements during a next control time step using a control technique including three steps of aggregation, optimization and dispatch of a control signal to clusters of devices.

Any of the methods described above can be performed by one or more computer application programs running on the computer system by being loaded into a memory and run on or in association with an operating system such as Windows™ supplied by Microsoft Corp, USA, Linux, Android or similar. The computer system can include a main memory, preferably random access memory (RAM), and may also include a non-transitory hard disk drive and/or a removable non-transitory memory, and/or a non-transitory solid state memory. Non-transitory removable memory can be an optical disk such as a compact disc (CD-ROM or DVD-ROM), a magnetic tape, which is read by and written to by a suitable reader. The removable non-transitory memory can be a computer readable medium having stored therein computer software and/or data.

The non-volatile storage memory can be used to store persistent information that should not be lost if the computer system is powered down. The application programs may use and store information in the non-volatile memory. Other applications may be loaded into the memory and run on the computing system. The computer system may also include an interface for receiving information on the operating parameters of the devices in the clusters and their bidding functions, e.g. at each time step. The interface may be for receiving data from a local source, e.g. by input by a keyboard or from a peripheral memory device, e.g. from an optical disk such as a compact disc (CD-ROM or DVD-ROM), or from a magnetic tape, which is read by and written to by a suitable reader, or from solid state memory such as a flash drive or directly from sensors. The computer system can execute one or more embodiments disclosed herein. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. Hence, the computer system may include a communication interface. The communication interface allows software and data to be transferred between the computer system and external devices including networks or the “cloud”. Examples of communication interface may include a modem, a network interface such as an Ethernet card, a communication port, or a PCMCIA slot and card, etc. Software and data transferred via communication interface are in the form of signals which may be, for example, electronic, electromagnetic, optical, or other signals capable of being received by the communication interface. These signals are provided to communication interface via a local or remote communication channel. This communication channel carries signals and may be implemented using wire or cable, fibre optics, a phone line, a cellular phone link, an RF link, and/or other communication channels.

A non-transitory signal storage device can store computer-executable instructions that, when executed by at least one processor, perform any of the methods of the present invention or provide any means according to the present invention. Computer program products (also called computer control logic) can be stored in main memory and/or secondary memory. Computer programs products may also be received via a communication interface. Such computer program products, when run, enable the computer system to perform the features of the present invention as discussed herein.

Accordingly, such computer programs represent controllers of the computer system.

The software embodied in the computer program product is adapted to carry out the following functions and to provide the following means when the software is loaded onto the respective device or devices and executed on one or more processing engines such as microprocessors, ASIC's, FPGA's etc.:

operating an electrical power or heat supply network having at least one cluster of a plurality of heat or electrical energy consuming devices and virtual simulated tracer devices to simulate a plurality of the electrical energy or heat consuming devices

The software embodied in the computer program product is adapted to carry out the following functions and to provide the following means when the software is loaded onto the respective device or devices and executed on one or more processing engines such as microprocessors, ASIC's, FPGA's etc.:

generating an aggregated model of a cluster which aggregates device state and parameter information of the entire cluster.

The software embodied in the computer program product is adapted to carry out the following functions and to provide the following means when the software is loaded onto the respective device or devices and executed on one or more processing engines such as microprocessors, ASIC's, FPGA's etc.:

optimizing a cluster demand profile for a next time period by performing a optimization (e.g. central or distributed or in the cloud) of the aggregated model with the simulated tracer devices including the dynamics of the simulated tracer devices and generating a control action which is a direct or indirect power or energy value for the next time period.

The software embodied in the computer program product is adapted to carry out the following functions and to provide the following means when the software is loaded onto the respective device or devices and executed on one or more processing engines such as microprocessors, ASIC's, FPGA's etc.:

converting the control action to individual device or aggregated devices control signals.

The software embodied in the computer program product is adapted to carry out the following functions and to provide the following means when the software is loaded onto the respective device or devices and executed on one or more processing engines such as microprocessors, ASIC's, FPGA's etc.:

providing dispatching information to the cluster, based on the control signals, and the plurality of the electrical energy or heat consuming devices consuming electrical energy or heat in accordance with the dispatching information.

The software embodied in the computer program product is adapted to carry out the following functions and to provide the following means when the software is loaded onto the respective device or devices and executed on one or more processing engines such as microprocessors, ASIC's, FPGA's etc.:

steps of aggregation, optimization and dispatch.

The software embodied in the computer program product is adapted to carry out the following functions and to provide the following means when the software is loaded onto the respective device or devices and executed on one or more processing engines such as microprocessors, ASIC's, FPGA's etc.:

the dispatching information is sent as a broadcast signal.

The software embodied in the computer program product is adapted to carry out the following functions and to provide the following means when the software is loaded onto the respective device or devices and executed on one or more processing engines such as microprocessors, ASIC's, FPGA's etc.:

including both dynamics of the simulated tracer devices and a dispatch algorithm explicitly in the central optimization.

The software embodied in the computer program product is adapted to carry out the following functions and to provide the following means when the software is loaded onto the respective device or devices and executed on one or more processing engines such as microprocessors, ASIC's, FPGA's etc.:

heat or electrical energy consuming devices are any thermostatically controlled loads (TCL) and/or
the TCLs are any of air conditioners, refrigerators, electric water heaters, thermal storage systems, buildings including heating, district, town or regional scale heat storage schemes, water or ice-slush tanks.

The software embodied in the computer program product is adapted to carry out the following functions and to provide the following means when the software is loaded onto the respective device or devices and executed on one or more processing engines such as microprocessors, ASIC's, FPGA's etc.:

the simulated tracer devices are based on second order models of representative heat or electrical energy consuming devices in the cluster. Higher order models are reported in [26].

The software embodied in the computer program product is adapted to carry out the following functions and to provide the following means when the software is loaded onto the respective device or devices and executed on one or more processing engines such as microprocessors, ASIC's, FPGA's etc.:

identifying the simulated tracer devices in a nonintrusive manner using Machine Learning (ML) techniques.

The software embodied in the computer program product is adapted to carry out the following functions and to provide the following means when the software is loaded onto the respective device or devices and executed on one or more processing engines such as microprocessors, ASIC's, FPGA's etc.:

the second order models are equivalent thermal parameter (ETP) models.

The software embodied in the computer program product is adapted to carry out the following functions and to provide the following means when the software is loaded onto the respective device or devices and executed on one or more processing engines such as microprocessors, ASIC's, FPGA's etc.:

the cluster demand profile for the cluster is derived based on sampled simulated tracer device parameters.

The software embodied in the computer program product is adapted to carry out the following functions and to provide the following means when the software is loaded onto the respective device or devices and executed on one or more processing engines such as microprocessors, ASIC's, FPGA's etc.:

the optimizing step is solved for a plurality of simulated tracer devices using Linear Programming (LP).

The software embodied in the computer program product is adapted to carry out the following functions and to provide the following means when the software is loaded onto the respective device or devices and executed on one or more processing engines such as microprocessors, ASIC's, FPGA's etc.:

constraining the simulated tracer device simulated consumption of energy for each future optimization time steps to respective piece-wise linear bid functions, and/or

Local control of the devices in a cluster by a demand response adaptor as disclosed in EP-A-2 618 445 which is incorporated herein by reference.

Any of the above software may be implemented as a computer program product which has been compiled for a processing engine in any of the servers or nodes of the network. The computer program product may be stored on a non-transitory signal storage medium such as an optical disk (CD-ROM or DVD-ROM), a digital magnetic tape, a magnetic disk, a solid state memory such as a USB flash memory, a ROM, or in the cloud etc.

1-50. (canceled)

51. A method for operating an electrical power or heat supply network having at least one cluster of a plurality of heat or electrical energy consuming devices, the method comprising:
identifying simulated tracer devices to simulate a plurality of the electrical energy or heat consuming devices;
generating an aggregated model of a cluster which aggregates device state and parameter information of the entire cluster;
optimizing a cluster demand profile for a next time period by performing an optimization of the aggregated model with the simulated tracer devices including the dynamics of the simulated tracer devices and generating a control action which is a direct or indirect power or energy value for the next time period,
converting the control action to individual device or aggregated devices control signals;
providing dispatching information to the cluster, based on the control signals, and
the plurality of the electrical energy or heat consuming devices consuming electrical energy or heat in accordance with the dispatching information.

52. The method of claim 51 comprising the steps of aggregation, optimization and dispatch.

53. The method of claim 51, wherein the dispatching information is sent as a broadcast signal.

54. The method of claim 51 including both dynamics of the simulated tracer devices and a dispatch algorithm explicitly in the central optimization.

55. The method of claim 51, wherein heat or electrical energy consuming devices are thermostatically controlled loads (TCL).

56. The method of claim 55, wherein controlled loads are any of air conditioners, refrigerators, electric water heaters, thermal storage systems, buildings including heating, district, town or regional scale heat storage schemes, water or ice-slush tanks.

57. The method of claim 51, wherein the simulated tracer devices are based on second order models or higher models of representative heat or electrical energy consuming devices in the cluster.

58. The method of claim 57, wherein identifying the simulated tracer devices is performed in a nonintrusive manner using Machine Learning (ML) techniques.

59. The method of claim 57, wherein the second order models are equivalent thermal parameter (ETP) models.

60. The method of claim 51, wherein the cluster demand profile for the cluster is derived based on sampled simulated tracer device parameters.

61. The method of claim 51, wherein the optimizing step is solved for a plurality of simulated tracer devices using Linear Programming (LP).

62. The method of claim 51, further comprising constraining the simulated tracer device simulated consumption of energy for each future optimization time steps to respective piece-wise linear bid functions.

63. A computer based method for operating an electrical power or heat supply network having at least one cluster of a plurality of heat or electrical energy consuming devices and virtual simulated tracer devices to simulate a plurality of the electrical energy or heat consuming devices, the method comprising:
generating an aggregated model of a cluster which aggregates device state and parameter information of the entire cluster,
optimizing a cluster demand profile for a next time period by performing an optimization of the aggregated model with the simulated tracer devices including the dynamics of the simulated tracer devices and generating a control action which is a direct or indirect power or energy value for the next time period,
converting the control action to individual device or aggregated devices control signals, providing dispatching information to the cluster, based on the control signals, and the plurality of the electrical energy or heat consuming devices consuming electrical energy or heat in accordance with the dispatching information.

64. The method of claim 63, wherein the plurality of heat or electrical energy consuming devices are controlled by remote or local switching in accordance with the dispatch information.

65. The method of claim 51, wherein the simulated tracer devices are identified by a Goodness of Fit test.

66. A computer based system for operating an electrical power or heat supply network having at least one cluster of a plurality of heat or electrical energy consuming devices and virtual simulated tracer devices to simulate a plurality of the electrical energy or heat consuming devices, the system comprising:
means for generating an aggregated model of a cluster which aggregates device state and parameter information of the entire cluster
means for optimizing a cluster demand profile for a next time period by performing an optimization of the aggregated model with the simulated tracer devices including the dynamics of the simulated tracer devices and generating a control action which is a direct or indirect power or energy value for the next time period,
means for converting the control action to individual device or aggregated devices control signals;
means for providing dispatching information to the cluster, based on the control signals, and the plurality of the electrical energy or heat consuming devices consuming electrical energy or heat in accordance with the dispatching information.

67. A controller for controlling operation an electrical power or heat supply network having at least one cluster of a plurality of heat or electrical energy consuming devices and virtual simulated tracer devices to simulate a plurality of the electrical energy or heat consuming devices, the controller comprising:
means for generating an aggregated model of a cluster which aggregates device state and parameter information of the entire cluster
means for optimizing a cluster demand profile for a next time period by performing an optimization of the aggregated model with the simulated tracer devices including the dynamics of the simulated tracer devices and generating a control action which is a direct or indirect power or energy value for the next time period,
means for converting the control action to individual device or aggregated devices control signals;
means for providing dispatching information to the cluster, based on the control signals, to allow the plurality of the electrical energy or heat consuming devices to consume electrical energy or heat in accordance with the dispatching information in a next time step.

68. A computer program product comprising software which when executed on a processing engine carries out any of the method steps of claim 51.

69. A non-transient signal storage means for storing the computer program product of claim 68.
